(19) United States
(12) Patent Application Publication
(10) Pub. No.: US 2026/0078690 A1
(43) Pub. Date: Mar. 19, 2026

(54) ASSEMBLY INTERFERENCE DETERMINATION DEVICE AND METHOD FOR CASING

(71) Applicant: Mitsubishi Heavy Industries, Ltd., Tokyo (JP)

(72) Inventors: Shunsuke MIZUMI, Tokyo (JP); Satoshi Kumagai, Tokyo (JP); Koji Ishibashi, Tokyo (JP); Takuya Nakano, Tokyo (JP)

(21) Appl. No.: 19/322,999

(22) Filed: Sep. 9, 2025

(30) Foreign Application Priority Data
Sep. 18, 2024 (JP) 2024-160975

(51) Int. Cl. F01D 25/28; F01D 25/24

(52) U.S. Cl. CPC F01D 25/285; F01D 25/243; F05D 2230/64

(57) ABSTRACT

An assembly interference determination device for a casing that includes a lower half part and an upper half part that are to be fastened to each other includes: a three-dimensional measurement data acquisition unit configured to acquire three-dimensional measurement data by three-dimensionally measuring a shape of a bolt disposed in one of the lower half part and the upper half part and a shape of a bolt hole disposed in the other of the lower half part and the upper half part; and an interference presence/absence determination unit configured to determine presence/absence of interference between the bolt and the bolt hole based on three-dimensional measurement data acquired by the three-dimensional measurement data acquisition unit.

### CROSS-REFERENCE TO RELATED APPLICATIONS

The present application claims priority to and incorporates by reference the entire contents of Japanese Patent Application No. 2024-160975 filed in Japan on Sep. 18, 2024.

### FIELD

The present disclosure relates to an assembly interference determination device and method for a casing.

### BACKGROUND

A steam turbine as a rotary machine includes a casing, a rotor, a turbine vane, and a turbine blade. Inside the casing, a rotor is supported in a rotatable manner, and a plurality of the turbine blades are fixed to the rotor at intervals in an axial direction. A plurality of the turbine vanes are fixed at intervals in the axial direction inside the casing. The turbine vane and the turbine blade are alternately arranged in the axial direction. The casing is constituted of a lower half part and an upper half part, which are divided into two parts, and they are fastened by a plurality of bolts to form a ring shape.

At the time of inspecting the steam turbine, the upper half part is detached from the lower half part by loosening the bolts, and an internal constituent part is inspected or repaired. When inspection or repair of the constituent part is completed, the upper half part is attached to the lower half part, and they are fastened to each other by the bolts. In the casing, inelastic deformation such as creep deformation may occur due to a thermal effect during operation. A technique of estimating a deformation amount of the casing is described, for example, in Patent Literature 1.

### CITATION LIST

### Patent Literature

Patent Literature 1: WO2023/162384

### SUMMARY

### Technical Problem

The creep deformation of the casing is deformation such that opposed attachment surfaces of the lower half part and the upper half part are curved in a convex shape or a concave shape. Thus, when the upper half part is attempted to be fastened to the lower half part after inspection work is finished, the attachment surfaces of the lower half part and the upper half part are not properly brought into contact with each other, and it becomes difficult to obtain uniform and sufficient bearing stress, so that steam leakage may be caused. In the casing, the lower half part and the upper half part are fastened to each other by the bolts in a state in which an upper attachment surface of the lower half part and a lower attachment surface of the upper half part are in close contact with each other, so that when creep deformation occurs in the upper attachment surface of the lower half part or the lower attachment surface of the upper half part, a stud bolt or a bolt hole is inclined. From the first, there is a margin slightly less than few millimeters in a bolt main body (including a screw thread) with respect to the bolt hole of a combustor casing chamber, so that there has been little trouble at the time of disassembly or assembly even if the combustor casing chamber is slightly deformed. However, specifically, a thermal deformation amount of the combustor casing chamber has been increased following increase in a main steam temperature to ultra-high levels in recent years, so that influence of inclination of the bolt hole cannot be ignored. For example, in a case in which the thermal deformation amount is large, the stud bolt of the lower half part may interfere with the bolt hole of the upper half part and cannot be inserted therein without reworking of the bolt hole.

The present disclosure solves the problem described above, and an object thereof is to provide an assembly interference determination device and method for a casing for enabling interference at the time of casing assembly to be estimated with high accuracy.

### Solution to Problem

To solve the above object, an assembly interference determination device for a casing that includes a lower half part and an upper half part that are to be fastened to each other, according to the present disclosure includes: a three-dimensional measurement data acquisition unit configured to acquire three-dimensional measurement data by three-dimensionally measuring a shape of a bolt disposed in one of the lower half part and the upper half part and a shape of a bolt hole disposed in the other of the lower half part and the upper half part; and an interference presence/absence determination unit configured to determine presence/absence of interference between the bolt and the bolt hole based on the three-dimensional measurement data acquired by the three-dimensional measurement data acquisition unit.

An assembly interference determination method for a casing that includes a lower half part and an upper half part that are to be fastened to each other, according to the present disclosure includes: acquiring three-dimensional measurement data by three-dimensionally measuring a shape of a bolt disposed in one of the lower half part and the upper half part and a shape of a bolt hole disposed in the other of the lower half part and the upper half part; and determining presence/absence of interference between the bolt and the bolt hole based on the acquired three-dimensional measurement data.

### Advantageous Effects of Invention

With the assembly interference determination device and method for the casing according to the present disclosure, interference at the time of casing assembly can be estimated with high accuracy.

### BRIEF DESCRIPTION OF DRAWINGS

FIG. 1 is a schematic diagram illustrating an internal configuration of a steam turbine.

FIG. 2 is a schematic diagram illustrating an attachment relation between a lower half part and an upper half part.

FIG. 3 is a schematic diagram illustrating deformed shapes of the lower half part and the upper half part.

FIG. 4 is a block diagram illustrating an assembly interference determination device for a casing in an embodiment.

FIG. 5 is a flowchart illustrating processing of an assembly interference determination method for the casing in the present embodiment.

FIG. 6 is a flowchart illustrating processing of a bolt shape estimation method.

FIG. 7 is an explanatory diagram for explaining a shape estimation method for a front end portion of a bolt.

FIG. 8 is a flowchart illustrating processing of interference determination method for the bolt and a bolt hole.

FIG. 9 is a plan view of the casing for explaining interference determination processing for the bolt and the bolt hole.

FIG. 10 is an explanatory diagram for explaining a non-contact determination result for the bolt and the bolt hole.

FIG. 11 is an explanatory diagram for explaining a contact determination result for the bolt and the bolt hole.

FIG. 12 is an explanatory diagram for explaining optimization processing when the bolt is not in contact with the bolt hole.

FIG. 13 is an explanatory diagram for explaining optimization processing when the bolt is in contact with the bolt hole.

### DESCRIPTION OF EMBODIMENTS

The following describes preferred embodiments of the present disclosure in detail with reference to the drawings. The present disclosure is not limited to the embodiments. In a case in which there are a plurality of embodiments, the present disclosure encompasses a combination of the embodiments. Constituent elements in the embodiment encompasses a constituent element that is easily conceivable by those skilled in the art, and substantially the same constituent element, what is called an equivalent.

### Steam Turbine

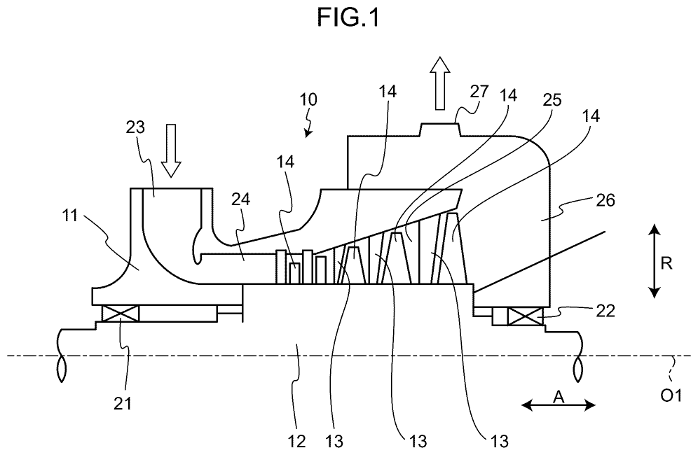

In a first embodiment, the following describes an assembly interference determination device and a method for a casing applied to a steam turbine as a rotary machine. However, the rotary machine is not limited to the steam turbine, and it can be applied to a configuration in which a rotating body is supported to be rotatable with respect to a stationary body such as a gas turbine or a compressor. FIG. 1 is a schematic diagram illustrating an internal configuration of the steam turbine.

As illustrated in FIG. 1, a steam turbine (rotary machine) 10 includes a casing 11, a rotor 12, a turbine vane 13, and a turbine blade 14.

The casing 11 has a hollow shape, and the rotor 12 is arranged therein along a horizontal direction. The rotor 12 is supported to be rotatable about a center axis O by bearings 21 and 22 disposed in the casing 11 (or a foundation of a plant). A plurality of the turbine vanes 13 are fixed to an inner peripheral part of the casing 11 at intervals in an axial direction A of the rotor 12. A plurality of the turbine blades 14 are fixed to an outer peripheral part of the rotor 12 at intervals in the axial direction A. The turbine vanes 13 are arranged along a radial direction R of the rotor 12 at intervals in a circumferential direction of the rotor 12. The turbine blades 14 are arranged along the radial direction R of the rotor 12 at intervals in the circumferential direction of the rotor 12, and the turbine vane 13 and the turbine blade 14 are alternately arranged in the axial direction A.

In the casing 11, a steam supply port 23 is disposed at one end part in the axial direction A. The steam supply port 23 communicates with a blade row part 25 in which the turbine vanes 13 and the turbine blades 14 are arranged via a steam passage 24. The blade row part 25 communicates with an exhaust chamber 26. In the casing 11, a steam ejection port 27 is disposed at the other end part in the axial direction A. The steam ejection port 27 communicates with the exhaust chamber 26.

High-pressure steam is supplied from the steam supply port 23 to the blade row part 25 through the steam passage 24. When the steam passes through the turbine vanes 13 and the turbine blades 14, the rotor 12 is driven and rotated via each of the turbine blades 14. A power generator (not illustrated) is coupled to the rotor 12, and the power generator is driven by driving force of the rotor 12. The steam that has driven each of the turbine blades 14 is ejected to the outside from the steam ejection port 27 through the exhaust chamber 26.

### Creep Deformation of Casing

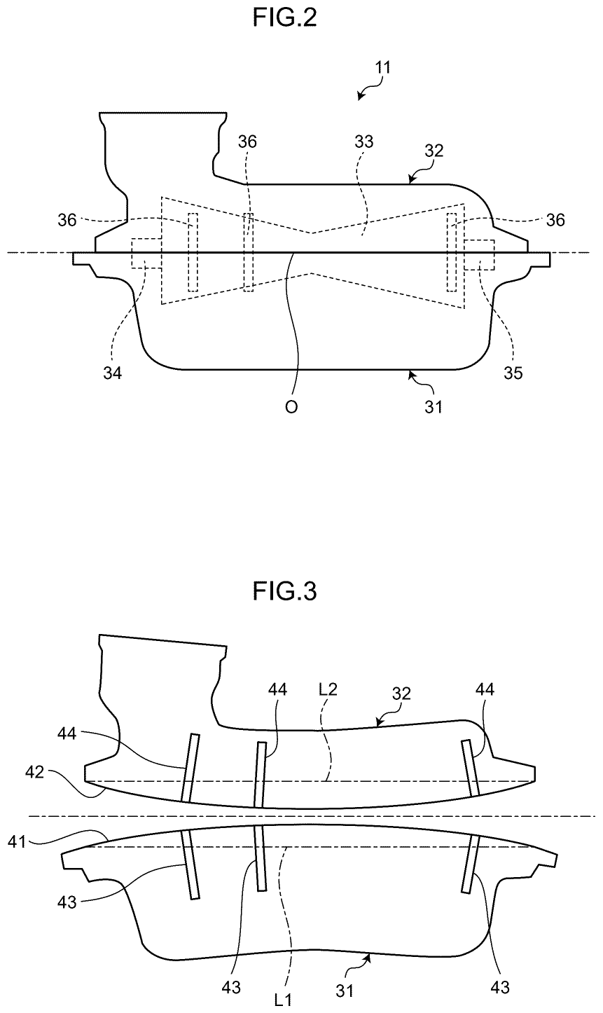

FIG. 2 is a schematic diagram illustrating an attachment relation between a lower half part and an upper half part, and FIG. 3 is a schematic diagram illustrating deformed shapes of the lower half part and the upper half part.

As illustrated in FIG. 2, the casing 11 includes a lower half part 31 and an upper half part 32. A lower housing space part is disposed inside the lower half part 31. The upper half part 32 is arranged on an upper side of the lower half part 31. An upper housing space part is disposed inside the upper half part 32. A turbine 33 is housed inside the casing 11. The turbine 33 is configured by disposing the turbine blades 14 on the outer peripheral part of the rotor 12 (regarding both, refer to FIG. 1). The turbine 33 is arranged in the lower housing space part of the lower half part 31 and the upper housing space part of the upper half part 32. The turbine 33 is supported to be rotatable about the center axis O by a pair of bearings 34 and 35 that are supported by the lower half part 31 and the upper half part 32. In the casing 11, the lower half part 31 and the upper half part 32 are fastened to each other by a plurality of bolts 36 in a state in which the turbine 33 is housed inside the casing 11.

In the casing 11, creep deformation occurs due to a thermal effect during operation. At the time of inspecting the steam turbine 10, the upper half part 32 is detached from the lower half part 31. At this point, the lower half part 31 and the upper half part 32 are deformed because constraint by the bolt 36 is released. As illustrated in FIG. 3, for example, creep deformation of the lower half part 31 is deformation such that the lower attachment surface 41 is curved to have a convex shape toward an upper side, and creep deformation of the upper half part 32 is deformation such that the upper attachment surface 42 is curved to have a convex shape toward a lower side. Due to this, at the time of assembling the upper half part 32 to the lower half part 31, it is difficult to fasten them to each other again. At the time of disassembling the lower half part 31 and the upper half part 32, the screw thread of the bolt 36 may interfere with the bolt holes 43 and 44. However, the creep deformation of the lower half part 31 and the upper half part 32 is not limited to such deformation.

That is, the bolt holes 43 and 44 are formed in the lower half part 31 and the upper half part 32, the bolt holes 43 and 44 through which the bolts 36 (refer to FIG. 2) for fastening the lower half part 31 to the upper half part 32 are inserted. The bolt holes 43 and 44 are disposed along a direction substantially orthogonal to the lower attachment surface 41 and the upper attachment surface 42. When the lower attachment surface 41 of the lower half part 31 or the upper attachment surface 42 of the upper half part 32 is deformed, the bolt holes 43 and 44 are inclined in a direction opposite to a vertical direction, and angles of the bolt hole 43 of the lower half part 31 and the bolt hole 44 of the upper half part 32 become different from each other. Accordingly, a gap between the bolt 36 and the bolt holes 43 and 44 may be reduced, and workability may be deteriorated to delay disassembling/assembling work. Furthermore, if the angles of the bolt 36 and the bolt holes 43 and 44 are largely different from each other, there is a possibility that the bolt 36 cannot be inserted into the bolt holes 43 and 44, and the lower half part 31 and the upper half part 32 cannot be fastened to each other.

### Assembly Interference Determination Device

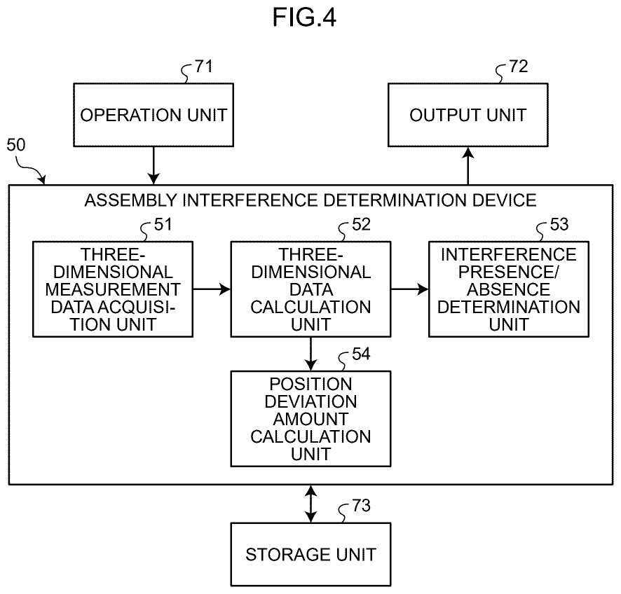

FIG. 4 is a block diagram illustrating the assembly interference determination device for the casing in the present embodiment.

As illustrated in FIG. 3 and FIG. 4, the assembly interference determination device for the casing (hereinafter, referred to as an assembly interference determination device) 50 determines interference between the bolt 36 and the bolt holes 43 and 44 when the upper half part 32 is assembled to the lower half part 31 after the upper half part 32 is detached from the lower half part 31 of the casing 11 and various kinds of inspection, repair, and the like are performed. The assembly interference determination device 50 can also estimate a deformation amount (deviation amount) of the bolt 36 and the bolt holes 43 and 44.

As illustrated in FIG. 4, the assembly interference determination device 50 includes a three-dimensional measurement data acquisition unit 51, a three-dimensional data calculation unit 52, an interference presence/absence determination unit 53, and a position deviation amount calculation unit 54. The assembly interference determination device 50 is a control device, and the control device is a controller. For example, it is implemented when various computer programs stored in a storage unit are executed by a central processing unit (CPU), a micro processing unit (MPU), and the like using a RAM as a working area.

To the assembly interference determination device 50, an operation unit 71, an output unit 72, and a storage unit 73 are connected.

The three-dimensional measurement data acquisition unit 51 is, for example, a non-contact type three-dimensional measuring device. The three-dimensional measurement data acquisition unit 51 acquires a three-dimensional image when a laser displacement gauge projects laser light and the like in a slit shape onto the lower half part 31 or the upper half part 32, for example, and a camera measures pattern light. Specifically, when the upper half part 32 is detached from the lower half part 31, the three-dimensional measurement data acquisition unit 51 three-dimensionally measures an inner surface shape of the lower half part 31 and an inner surface shape of the upper half part 32 to acquire three-dimensional measurement data. Herein, an internal shape includes the casing 11 (the lower half part 31, the upper half part 32), the attachment surfaces 41 and 42, and the like.

In this case, the bolt holes 43 and 44 are formed on the attachment surfaces 41 and 42, and three-dimensional measurement data of the bolt holes 43 and 44 is also acquired. When a bolt for fastening (stud bolt) is left in the lower half part 31, three-dimensional measurement data of the bolt 36 is also acquired.

The three-dimensional measurement data acquired by the three-dimensional measurement data acquisition unit 51 includes three-dimensional data of the lower attachment surface 41 of the lower half part 31 (hereinafter, referred to as lower three-dimensional data) and three-dimensional data of the upper attachment surface 42 of the upper half part 32 (hereinafter, referred to as upper three-dimensional data). The three-dimensional data of the lower attachment surface 41 of the lower half part 31 and the upper attachment surface 42 of the upper half part 32 is, for example, three-dimensional coordinate data of the lower attachment surface 41 of the lower half part 31 and the upper attachment surface 42 of the upper half part 32. The three-dimensional coordinate data is data of absolute coordinates of the upper half part 32 and the lower half part 31 with respect to origins (X0, Y0, Z0) set in advance.

The three-dimensional measurement data acquisition unit 51 outputs the acquired three-dimensional measurement data of the respective attachment surfaces 41 and 42 of the lower half part 31 and the upper half part 32 to the three-dimensional data calculation unit 52. The three-dimensional data calculation unit 52 calculates, based on the three-dimensional measurement data, three-dimensional data of the bolt 36 for fastening the lower half part 31 to the upper half part 32, especially, three-dimensional data of a front end portion of the bolt 36.

In this case, as described later, in a case in which the three-dimensional measurement data is the bolt hole 43 formed on the attachment surface 41 of the lower half part 31 or the bolt hole 44 formed on the attachment surface 42 of the upper half part 32, the three-dimensional data of the bolt 36 is calculated based on design data and three-dimensional data (three-dimensional coordinate data) of the bolt holes 43 and 44. In a case in which the three-dimensional measurement data is a partial shape of the bolt 36, the three-dimensional data of the bolt 36 is calculated based on design data and three-dimensional data (three-dimensional coordinate data) of the partial shape of the bolt 36.

The three-dimensional data calculation unit 52 outputs the calculated three-dimensional data of the bolt 36 to the position deviation amount calculation unit 54. By comparing the three-dimensional data (or three-dimensional measurement data) with the design data of the lower half part 31 and the upper half part 32, the position deviation amount calculation unit 54 calculates a position deviation amount of the bolt 36 or the bolt holes 43 and 44. Herein, the position deviation amount is a difference between shape data of the lower half part 31 and the upper half part 32 before creep deformation occurs, that is, the design data, and shape data of the lower half part 31 and the upper half part 32 after the creep deformation, that is, after use. However, the shape data of the lower half part 31 and the upper half part 32 before the creep deformation occurs may be the shape data of the lower half part 31 and the upper half part 32 that is three-dimensionally measured before use.

The three-dimensional data calculation unit 52 outputs the calculated position deviation amount to the interference presence/absence determination unit 53. The interference presence/absence determination unit 53 determines whether the position deviation amount calculated by the position deviation amount calculation unit 54 falls within a prescribed range set in advance. That is, the interference presence/absence determination unit 53 determines whether the position deviation amount falls within the prescribed range set in advance and whether the lower half part 31 and the upper half part 32 can be properly fastened to each other by the bolts 36. Herein, the prescribed range set in advance is a relative position deviation amount with which the bolt 36 can be properly inserted through the bolt holes 43 and 44 when the lower half part 31 is assembled to the upper half part 32, and the lower half part 31 and the upper half part 32 can be properly fastened to each other.

The operation unit 71 is connected to the assembly interference determination device 50. The operation unit 71 can be operated by an operator. When the operator operates the operation unit 71, various command signals can be input to the assembly interference determination device 50. The operation unit 71 is, for example, a keyboard or a touch display.

The output unit 72 is connected to the assembly interference determination device 50. The output unit 72 outputs evaluation content about the casing 11 evaluated by the assembly interference determination device 50. The output unit 72 is, for example, a monitor or a printer.

The storage unit 73 is connected to the assembly interference determination device 50. The storage unit 73 stores a computer program for evaluating the casing 11 by the assembly interference determination device 50. The storage unit 73 also stores the three-dimensional measurement data of the lower half part 31 and the upper half part 32 acquired by the three-dimensional measurement data acquisition unit 51, the three-dimensional data of the bolt 36 calculated by the three-dimensional data calculation unit 52, the position deviation amount calculated by the position deviation amount calculation unit 54, and the like.

### Assembly Interference Determination Method

FIG. 5 is a flowchart illustrating processing of an assembly interference determination method for the casing in the present embodiment.

As illustrated in FIG. 4 and FIG. 5, at Step S11, when the upper half part 32 is detached from the lower half part 31, the three-dimensional measurement data acquisition unit 51 three-dimensionally measures the inner surface shape of the lower half part 31 to acquire the three-dimensional measurement data. Herein, the three-dimensional measurement data is the lower three-dimensional data of the lower attachment surface 41 of the lower half part 31. The lower three-dimensional data includes three-dimensional coordinate data of the bolt 36 or the bolt hole 43 on the lower attachment surface 41.

At Step S12, the three-dimensional data calculation unit 52 calculates the three-dimensional data of the bolt 36, especially, the three-dimensional data of the front end portion of the bolt 36, based on the lower three-dimensional data. At Step S13, the position deviation amount calculation unit 54 calculates the position deviation amount of the bolt 36 by comparing the three-dimensional data of the bolt 36 with the design data. Herein, a cause of position deviation of the bolt 36 includes inclination that is caused when the bolt 36 falls down due to curved deformation of the attachment surfaces 41 and 42 of the combustor casing chamber, and a change in distance between the bolts 36 due to local expansion or contraction of the entire combustor casing chamber, for example.

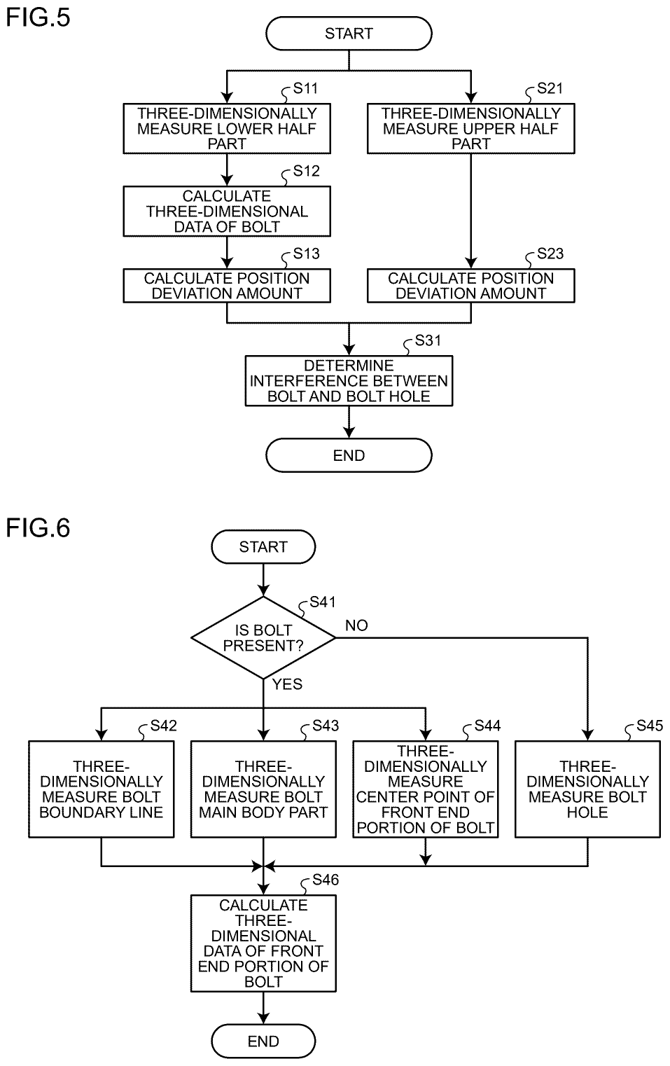

As illustrated in FIG. 5 and FIG. 6, processing at Steps S21 to S23 is performed in parallel with the processing at Steps S11 to S13.

At Step S21, when the upper half part 32 is detached from the lower half part 31, the three-dimensional measurement data acquisition unit 51 three-dimensionally measures the inner surface shape of the upper half part 32 to acquire the three-dimensional measurement data. Herein, the three-dimensional measurement data is the upper three-dimensional data of the upper attachment surface 42 of the upper half part 32. The upper three-dimensional data includes three-dimensional coordinate data of the bolt hole 44 on the upper attachment surface 42. At Step S23, the position deviation amount calculation unit 54 calculates the position deviation amount of the bolt hole 44, that is, inclination of the bolt hole 44, a distance between the bolts, and the like by comparing the three-dimensional data of the bolt hole 44 with the design data.

At Step S31, the interference presence/absence determination unit 53 determines whether the position deviation amount of the bolt 36 in the lower half part 31 and the position deviation amount of the bolt hole 44 in the upper half part 32 calculated by the three-dimensional data calculation unit 52 fall within the prescribed range set in advance. That is, the interference presence/absence determination unit 53 determines whether the position deviation amount falls within the prescribed range set in advance and whether the lower half part 31 and the upper half part 32 can be properly fastened to each other by the bolts 36. Specifically, the interference presence/absence determination unit 53 determines presence/absence of interference between the bolt 36 and the bolt hole 44 based on the position deviation amount of the bolt 36 in the lower half part 31 and the position deviation amount of the bolt hole 44 in the upper half part 32 calculated by the three-dimensional data calculation unit 52.

In a case in which a future deformation amount needs to be more accurately predicted for the lower half part 31 and the upper half part 32 in the assembly interference determination processing for the casing, a model reflecting the three-dimensional measurement data may be created, and after performing creep analysis, presence/absence of interference between the bolt 36 and the bolt hole 44 may be determined again.

### Bolt Shape Estimation Method

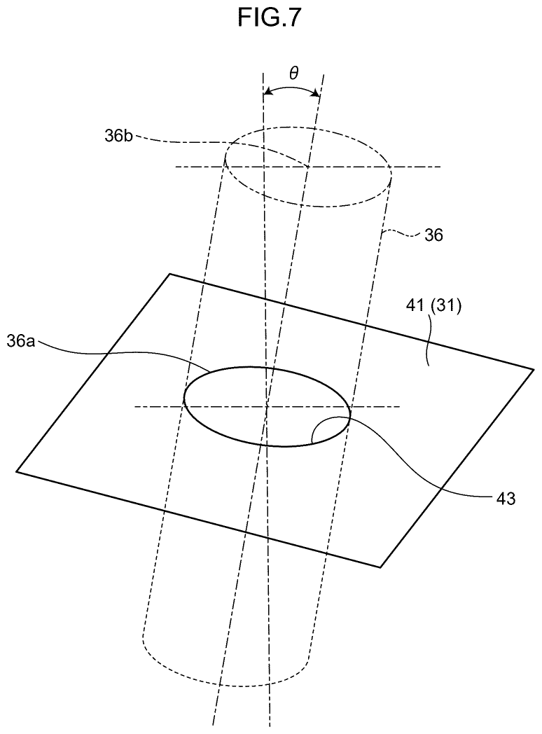

Herein, the following specifically describes processing of calculating the three-dimensional data of the front end portion of the bolt 36 by the three-dimensional data calculation unit 52 at Step S12 described above. FIG. 6 is a flowchart illustrating processing of a bolt shape estimation method, and FIG. 7 is an explanatory diagram for explaining a shape estimation method for a front end portion of the bolt.

As illustrated in FIG. 6 and FIG. 7, at Step S41, it is determined whether the stud bolt 36 is present in the lower half part 31. If it is determined that the stud bolt 36 is present in the lower half part 31 (Yes), any of the Steps S42, S43, and S44 is performed. At Step S42, the three-dimensional measurement data acquisition unit 51 acquires three-dimensional measurement data of a bolt boundary line 36a between the lower attachment surface 41 of the lower half part 31 and the bolt 36. At Step S46, the three-dimensional data calculation unit 52 calculates three-dimensional data of the front end portion (front end surface) of the bolt 36 based on the three-dimensional measurement data of the bolt boundary line 36a of the bolt 36 and the design data of the bolt 36.

At Step S43, the three-dimensional measurement data acquisition unit 51 acquires three-dimensional measurement data of a main body part of the bolt 36 in the lower half part 31. The three-dimensional measurement data of the main body part of the bolt 36 is three-dimensional measurement data of a cylindrical portion that is at least part of the bolt 36 from the bolt boundary line 36a to the front end portion. At Step S46, the three-dimensional data calculation unit 52 calculates three-dimensional data of the front end portion (front end surface) of the bolt 36 based on the three-dimensional measurement data of the main body part of the bolt 36 and the design data of the bolt 36. Herein, the design data of the bolt is a height from a flange surface to the front end portion of the bolt, a diameter of a bolt screw part, and the like.

At Step S44, the three-dimensional measurement data acquisition unit 51 acquires three-dimensional measurement data of a center point 36b of the front end portion of the bolt 36 in the lower half part 31. At Step S46, the three-dimensional data calculation unit 52 calculates three-dimensional data of the front end portion (front end surface) of the bolt 36 based on the three-dimensional measurement data of the center point 36b of the front end portion of the bolt 36 and the design data of the bolt 36.

At Step S41, if it is determined that the stud bolt 36 is not present in the lower half part 31 (No), the three-dimensional measurement data acquisition unit 51 acquires three-dimensional measurement data of the bolt hole 43 on the lower attachment surface 41 of the lower half part 31 at Step S45. At Step S46, the three-dimensional data calculation unit 52 calculates three-dimensional data of the front end portion (front end surface) of the bolt 36 based on the three-dimensional measurement data of the bolt hole 43 and the design data of the bolt 36.

In the lower half part 31, creep deformation occurs in the lower attachment surface 41, so that it can be considered that the bolt 36 is inclined by a predetermined angle θ with respect to a vertical line. A three-dimensional shape of the bolt 36 mounted into the bolt hole 43 on the lower attachment surface 41 of the lower half part 31 is obtained in advance as the design data. Thus, by applying the three-dimensional shape data of the bolt 36 to any of the three-dimensional measurement data of the bolt boundary line 36a, the three-dimensional measurement data of the main body part of the bolt 36, the three-dimensional measurement data of the center point 36b of the front end portion of the bolt 36, and the three-dimensional measurement data of the bolt hole 43, three-dimensional data of the front end portion (front end surface) of the bolt 36 can be calculated.

### Interference Determination Method for Bolt and Bolt Hole

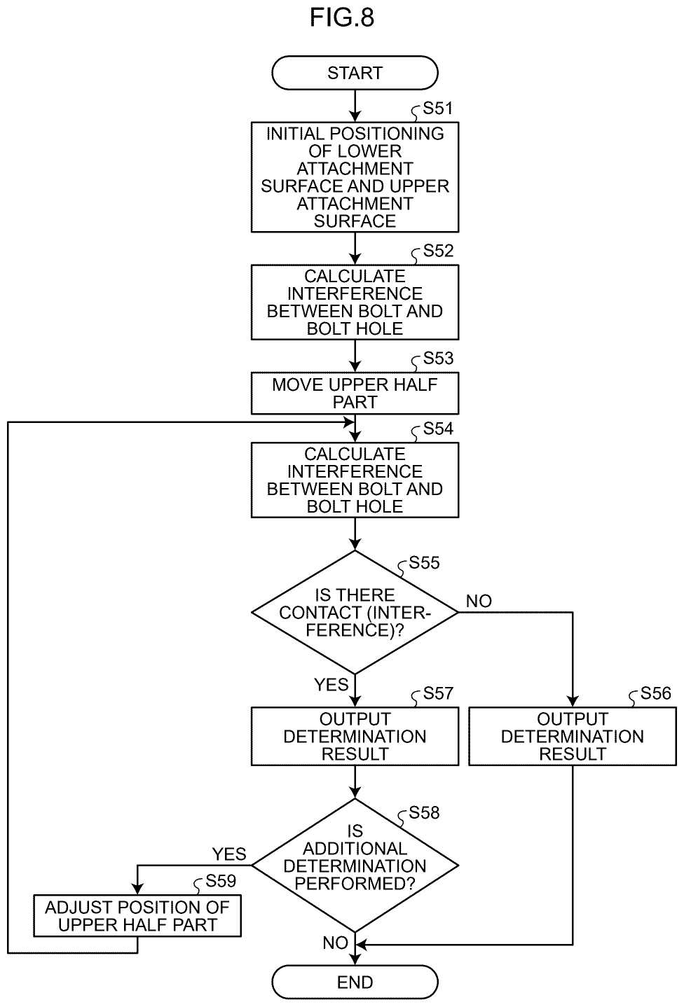

The following specifically describes processing of determining interference between the bolt 36 and the bolt hole 44 by the interference presence/absence determination unit 53 at Step S31 described above. FIG. 8 is a flowchart illustrating processing of an interference determination method for the bolt and the bolt hole.

The interference presence/absence determination unit 53 determines whether the position deviation amount of the bolt 36 in the lower half part 31 and the position deviation amount of the bolt hole 44 in the upper half part 32 calculated by the three-dimensional data calculation unit 52 fall within the prescribed range set in advance. At Step S51, by positioning the upper half part 32 at an initial position with respect to the lower half part 31, initial positioning of the upper attachment surface 42 including the bolt hole 44 after deformation is performed with respect to the lower attachment surface 41 including the bolt 36 after deformation. Initial positioning of the upper attachment surface 42 with respect to the lower attachment surface 41 is performed in three-dimensional directions.

At Step S52, interference calculation is performed for the bolt 36 in the lower half part 31 and the bolt hole 44 in the upper half part 32. A method for interference calculation will be described later. At Step S53, the upper half part 32 is moved by a predetermined amount in a horizontal direction with respect to the lower half part 31. At Step S54, interference calculation is performed again for the bolt 36 in the lower half part 31 and the bolt hole 44 in the upper half part 32.

At Step S55, it is determined whether the bolt 36 in the lower half part 31 is in contact (interferes) with the bolt hole 44 in the upper half part 32. If it is determined that the bolt 36 in the lower half part 31 is not in contact (does not interfere) with the bolt hole 44 in the upper half part 32 (No), a determination result is output and the processing is ended at Step S56.

On the other hand, if it is determined that the bolt 36 in the lower half part 31 is in contact (interferes) with the bolt hole 44 in the upper half part 32 (Yes), a determination result is output at Step S57. At Step S58, it is determined whether to perform additional determination for determining whether the bolt 36 in the lower half part 31 is in contact (interferes) with the bolt hole 44 in the upper half part 32. If it is determined not to perform additional determination (No), the processing is ended. On the other hand, if it is determined to perform additional determination (Yes), position adjustment of the upper half part 32 is performed by moving the upper half part 32 in the horizontal direction with respect to the lower half part 31 at Step S59. The processing is then continued while returning to Step S54.

### Specific Example of Interference Determination for Bolt and Bolt Hole

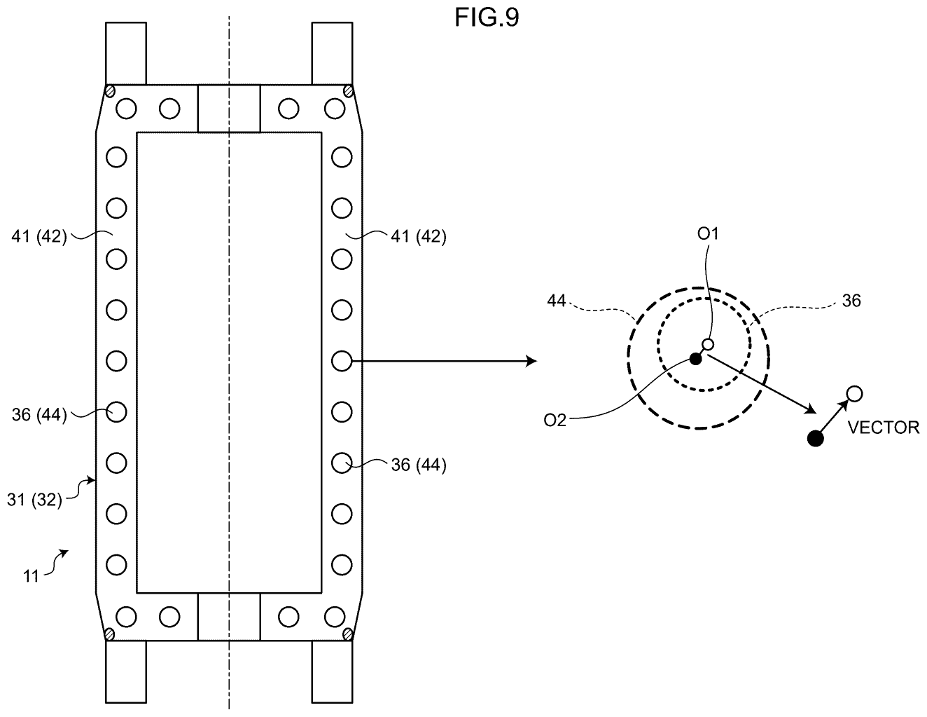

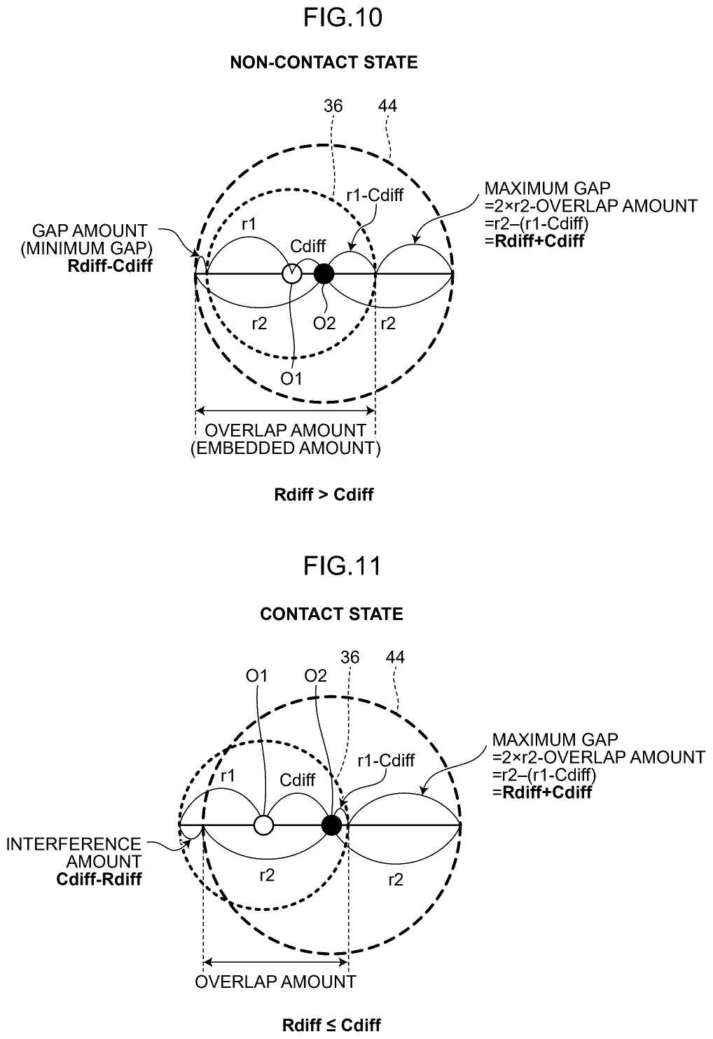

FIG. 9 is a plan view of the casing for explaining interference determination processing for the bolt and the bolt hole, FIG. 10 is an explanatory diagram for explaining a non-contact determination result for the bolt and the bolt hole, and FIG. 11 is an explanatory diagram for explaining a contact determination result for the bolt and the bolt hole.

FIG. 9 illustrates a relation between an approximate circle of the front end portion of the bolt 36 and an approximate circle of the bolt hole 44 at the front end portion of the bolt 36 in a state in which the upper attachment surface 42 of the upper half part 32 is in close contact with the lower attachment surface 41 of the lower half part 31. As illustrated in FIG. 9, a center of the front end surface of the bolt 36 is assumed to be O1, and a center of the bolt hole 44 is assumed to be O2. Herein, the bolt 36 is inclined with respect to the bolt hole 44, so that the center O1 of the front end surface of the bolt 36 is deviated from the center O2 of the bolt hole 44. A direction of deviation between the bolt 36 and the bolt hole 44 is indicated as a vector represented by an arrow, and a center-to-center distance between the center O1 and the center O2 is the position deviation amount, which is indicated as a length of the vector. FIG. 9 is displayed on the output unit 72.

FIG. 10 is a display example when the approximate circle of the front end surface of the bolt 36 and the approximate circle of the bolt hole 44 are in a non-contact state. As illustrated in FIG. 10, a radius of the approximate circle of the bolt 36 is assumed to be r1, and a radius of the approximate circle of the bolt hole 44 is assumed to be r2. In this case, the bolt 36 passes through the bolt hole 44 and a nut (not illustrated) is screwed onto the front end portion thereof, so that r1<r2 is satisfied. A difference between the radius r1 and the radius r2 is assumed to be Rdiff (r2−r1), and a center-to-center distance (amount of eccentricity) between the center O1 and the center O2 is assumed to be Cdiff.

Thus, a minimum gap between the approximate circle of the front end surface of the bolt 36 and the approximate circle of the bolt hole 44 is Rdiff−Cdiff, and a maximum gap is Rdiff+Cdiff. An overlap amount is a length of an overlap between the approximate circle of the front end surface of the bolt 36 and the approximate circle of the bolt hole 44 on a straight line passing through the center O1 of the approximate circle of the front end surface of the bolt 36 and the center O2 of the approximate circle of the bolt hole 44, and represented as r1+r2−Cdiff. Herein, Rdiff>Cdiff is satisfied, and a gap amount (minimum gap Rdiff−Cdiff) is secured between the approximate circle of the front end surface of the bolt 36 and the approximate circle of the bolt hole 44, so that it is determined that the approximate circle of the front end surface of the bolt 36 and the approximate circle of the bolt hole 44 are in a non-contact state.

FIG. 11 is a display example when the approximate circle of the front end surface of the bolt 36 and the approximate circle of the bolt hole 44 are in a contact state. As illustrated in FIG. 11, there is no minimum gap between the approximate circle of the front end surface of the bolt 36 and the approximate circle of the bolt hole 44, an interference amount is Rdiff−Cdiff, and the maximum gap is Rdiff+Cdiff. Herein, Rdiff≤Cdiff is satisfied, and there is no gap amount between the approximate circle of the front end surface of the bolt 36 and the approximate circle of the bolt hole 44 and the interference amount (Rdiff−Cdiff) is generated, so that it is determined that the approximate circle of the front end surface of the bolt 36 and the approximate circle of the bolt hole 44 are in a contact state.

FIG. 11 is an example in which the approximate circle of the front end surface of the bolt 36 and the approximate circle of the bolt hole 44 are in contact with each other while intersecting at two points, and it is determined to be a contact state. When the approximate circle of the front end surface of the bolt 36 and the approximate circle of the bolt hole 44 are in contact with each other at one point, it is also determined to be the contact state.

### Specific Example of Optimization Processing after Interference Determination for Bolt and Bolt Hole

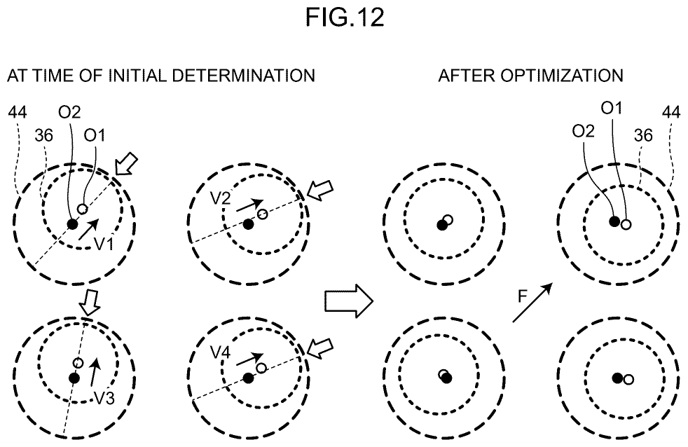

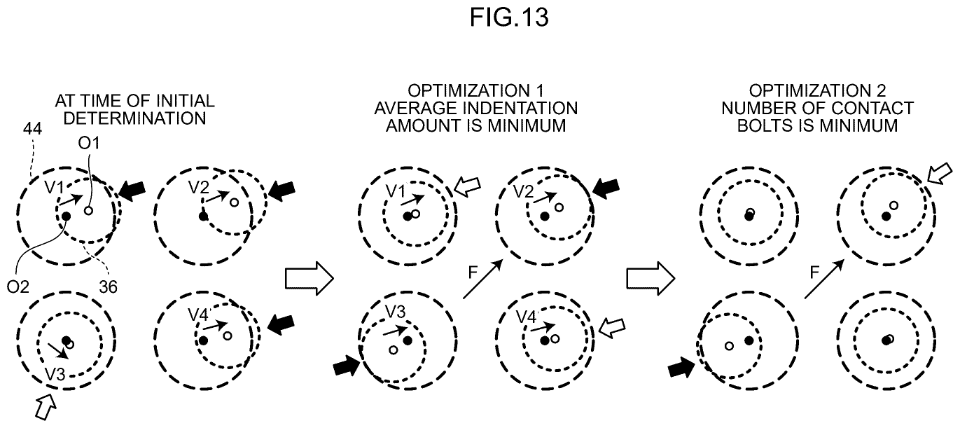

FIG. 12 is an explanatory diagram for explaining optimization processing when the bolt is not in contact with the bolt hole, and FIG. 13 is an explanatory diagram for explaining optimization processing when the bolt is in contact with the bolt hole.

FIG. 12 is a display example of the optimization processing when the bolt 36 and the bolt hole 44 are in a non-contact state. As illustrated in FIG. 12, at the time of initial determination, for example, the approximate circle of the front end surface of the bolt 36 and the approximate circle of the bolt hole 44 are in a non-contact state at four positions. At this point, a direction of deviation between the approximate circle of the front end surface of the bolt 36 and the approximate circle of the bolt hole 44 is represented by each of vectors V1, V2, V3, and V4, and the deviation amount is represented by a length of each of the vectors V1, V2, V3, and V4. A closest part of the approximate circle of the front end surface of the bolt 36 and the approximate circle of the bolt hole 44 is indicated by a solid-white arrow.

In such a non-contact state of the bolt 36 and the bolt hole 44, there is a large gap on the opposite side of the closest part of the approximate circle of the front end surface of the bolt 36 and the approximate circle of the bolt hole 44. Thus, the vectors V1, V2, V3, and V4 are weighted to be corrected corresponding to the gap amount between the approximate circle of the front end surface of the bolt 36 and the approximate circle of the bolt hole 44 to optimize the gap amount. That is, the upper half part 32 including the bolt hole 44 is moved by a predetermined amount in an arrow F direction to increase the gap amount at the closest part.

FIG. 13 is a display example of the optimization processing when the bolt 36 and the bolt hole 44 are in a contact state. As illustrated in FIG. 13, at the time of initial determination, for example, the approximate circle of the front end surface of the bolt 36 and the approximate circle of the bolt hole 44 are in a contact state at three positions. At this point, the direction of deviation between the approximate circle of the front end surface of the bolt 36 and the approximate circle of the bolt hole 44 is represented by each of the vectors V1, V2, V3, and V4, and the deviation amount is represented by a length of each of the vectors V1, V2, V3, and V4. The closest part of the approximate circle of the front end surface of the bolt 36 and the approximate circle of the bolt hole 44 is indicated by a solid-white arrow, and a contact part of the approximate circle of the front end surface of the bolt 36 and the approximate circle of the bolt hole 44 is indicated by a solid-black arrow.

In such a contact state of the bolt 36 and the bolt hole 44, there is a large gap on the opposite side of the contact part of the approximate circle of the front end surface of the bolt 36 and the approximate circle of the bolt hole 44 (vectors V1, V2, and V4). Thus, the vectors V1, V2, V3, and V4 are weighted to be corrected corresponding to the gap amount between the approximate circle of the front end surface of the bolt 36 and the approximate circle of the bolt hole 44 to optimize the gap amount. That is, the upper half part 32 including the bolt hole 44 is moved by a predetermined amount in the arrow F direction to reduce the number of contact parts. In optimization 1, the number of the contact parts of the approximate circle of the front end surface of the bolt 36 and the approximate circle of the bolt hole 44 is reduced from three (vectors V1, V2, and V4) to two (vectors V2 and V3).

In the optimization 1, there is a large gap on the opposite side of the contact part of the approximate circle of the front end surface of the bolt 36 and the approximate circle of the bolt hole 44 (vector V2). Thus, the vectors V1, V2, V3, and V4 are weighted to be corrected corresponding to the gap amount between the approximate circle of the front end surface of the bolt 36 and the approximate circle of the bolt hole 44 to optimize the gap amount. That is, the upper half part 32 including the bolt hole 44 is moved by a predetermined amount in the arrow F direction to reduce the number of contact parts. On the other hand, in optimization 2, the number of the contact parts of the approximate circle of the front end surface of the bolt 36 and the approximate circle of the bolt hole 44 is further reduced from two (vectors V2 and V3) to one (vector V3), but an indentation amount of the contact part of the vector V3 is larger than that in the optimization 1. That is, the optimization 1 assigns priority to minimization of an average indentation amount of all of the bolts 36, and the optimization 2 assigns priority to minimization of the number of the contact parts.

As illustrated in FIG. 4, the output unit 72 is connected to the assembly interference determination device 50. The output unit 72 displays a determination result of the interference presence/absence determination unit 53 in the assembly interference determination device 50 on a monitor, for example. Display content includes content in FIG. 9 to FIG. 13 described above. Specifically, a plan view of a state in which the upper half part 32 is assembled to the lower half part 31 is displayed, that is, the approximate circle of the front end surface of the bolt 36, the approximate circle of the bolt hole 44, the centers O1 and O2 of the respective approximate circles, the vector V, and the like are displayed. During the processing, displayed are the difference Rdiff between the radius r1 and the radius r2, the center-to-center distance (amount of eccentricity) Cdiff between the center O1 and the center O2, the gap amount or the interference amount (Rdiff−Cdiff), the closest part (arrow), the contact part (arrow), and the like.

In the embodiment described above, the shape of the bolt 36 disposed in the lower half part 31 and the shape of the bolt hole 44 disposed in the upper half part 32 are three-dimensionally measured, and presence/absence of interference between the bolt 36 and the bolt hole 44 is estimated. However, the configuration is not limited thereto. For example, the shape of the bolt 36 disposed in the upper half part 32 and the shape of the bolt hole 43 disposed in the lower half part 31 may be three-dimensionally measured, and presence/absence of interference between the bolt 36 and the bolt hole 43 may be estimated.

### Working Effect of Present Embodiment

The assembly interference determination device for the casing according to a first aspect includes: the three-dimensional measurement data acquisition unit 51 configured to acquire the three-dimensional measurement data by three-dimensionally measuring the shape of the bolt 36 disposed in one of the lower half part 31 and the upper half part 32 and the shape of the bolt hole 43 or 44 disposed in the other of the lower half part 31 and the upper half part 32; and the interference presence/absence determination unit 53 configured to determine presence/absence of interference between the bolt 36 and the bolt hole 43 or 44 based on the three-dimensional measurement data acquired by the three-dimensional measurement data acquisition unit 51.

With the assembly interference determination device for the casing according to the first aspect, presence/absence of interference between the bolt 36 and the bolt hole 43 or 44 based on the three-dimensional measurement data of the deformed lower half part 31 and upper half part 32, so that it is possible to determine whether the lower half part 31 and the upper half part 32 can be properly fastened to each other by the bolts 36. As a result, interference at the time of casing assembly can be estimated with high accuracy.

The assembly interference determination device for the casing according to a second aspect is the assembly interference determination device for the casing according to the first aspect in which the three-dimensional measurement data acquisition unit 51 acquires three-dimensional measurement data of the bolt boundary line between the attachment surface 41 of the lower half part 31 and the bolt 36, the three-dimensional data calculation unit 52 is provided to calculate three-dimensional data of the shape of the front end portion of the bolt 36 based on the three-dimensional measurement data of the bolt boundary line acquired by the three-dimensional measurement data acquisition unit 51, and the interference presence/absence determination unit 53 determines presence/absence of interference between the bolt 36 and the bolt hole 43 or 44 using the three-dimensional data of the shape of the front end portion of the bolt 36 calculated by the three-dimensional data calculation unit 52. Due to this, the three-dimensional measurement data of the bolt boundary line is used, so that only the three-dimensional measurement data of the attachment surfaces 41 and 42 needs to be acquired, and the interference determination processing can be simplified.

The assembly interference determination device for the casing according to a third aspect is the assembly interference determination device for the casing according to the first aspect in which the three-dimensional measurement data acquisition unit 51 acquires three-dimensional measurement data of the shape of the bolt 36 in the lower half part 31, the three-dimensional data calculation unit 52 is provided to calculate three-dimensional data of the shape of the front end portion of the bolt 36 based on the three-dimensional measurement data of the bolt 36 acquired by the three-dimensional measurement data acquisition unit 51, and the interference presence/absence determination unit 53 determines presence/absence of interference between the bolt 36 and the bolt hole 43 or 44 using the three-dimensional data of the shape of the front end portion of the bolt 36 calculated by the three-dimensional data calculation unit 52. Due to this, the three-dimensional measurement data of the bolt 36 is used, so that the interference determination processing can be performed with high accuracy.

The assembly interference determination device for the casing according to a fourth aspect is the assembly interference determination device for the casing according to the first aspect in which the three-dimensional measurement data acquisition unit 51 acquires three-dimensional measurement data of the center point of the front end portion of the bolt 36 in the lower half part 31, the three-dimensional data calculation unit 52 is provided to calculate three-dimensional data of the shape of the front end portion of the bolt 36 based on three-dimensional measurement data of the center point of the front end portion of the bolt 36 acquired by the three-dimensional measurement data acquisition unit 51, and the interference presence/absence determination unit 53 determines presence/absence of interference between the bolt 36 and the bolt hole 43 or 44 using the three-dimensional data of the shape of the front end portion of the bolt 36 calculated by the three-dimensional data calculation unit 52. Due to this, the three-dimensional measurement data of the center point of the front end portion of the bolt 36 is used, so that the interference determination processing can be performed with high accuracy.

The assembly interference determination device for the casing according to a fifth aspect is the assembly interference determination device for the casing according to the first aspect in which the three-dimensional measurement data acquisition unit 51 acquires three-dimensional measurement data of the shape of the bolt hole 43 or 44 on the attachment surface 41 or 42 of the lower half part 31 or the upper half part 32, the three-dimensional data calculation unit 52 is provided to calculate three-dimensional data of the shape of the front end portion of the bolt 36 to be mounted into the bolt hole 43 or 44 based on the three-dimensional measurement data of the shape of the bolt hole 43 or 44 acquired by the three-dimensional measurement data acquisition unit 51, and the interference presence/absence determination unit 53 determines presence/absence of interference between the bolt 36 and the bolt hole 43 or 44 using the three-dimensional data of the shape of the front end portion of the bolt 36 calculated by the three-dimensional data calculation unit 52. Due to this, the three-dimensional measurement data of the bolt hole 43 or 44 on the attachment surface 41 or 42 is used, so that only the three-dimensional measurement data of the attachment surfaces 41 and 42 needs to be acquired, and the interference determination processing can be simplified.

The assembly interference determination device for the casing according to a sixth aspect is the assembly interference determination device for the casing according to any one of the first aspect to the fifth aspect further including the position deviation amount calculation unit 54 configured to calculate the position deviation amount of the bolt 36 or the bolt holes 43 and 44 by comparing the three-dimensional measurement data acquired by the three-dimensional measurement data acquisition unit 51 with the design data of the lower half part 31 and the upper half part 32. Due to this, the position deviation amount of the bolt 36 or the bolt holes 43 and 44 is calculated by comparing the three-dimensional measurement data of the shape of the deformed lower half part 31 and upper half part 32 with the design data, so that the deformation amount of the casing 11 can be estimated with high accuracy. Furthermore, it is also possible to determine presence/absence of correction of the bolt holes 43 and 44 and estimate an optimum correction amount.

The assembly interference determination method for the casing according to a seventh aspect includes: acquiring the three-dimensional measurement data by three-dimensionally measuring the shape of the bolt 36 disposed in one of the lower half part 31 and the upper half part 32 and the shape of the bolt hole 43 or 44 disposed in the other of the lower half part 31 and the upper half part 32; and determining presence/absence of interference between the bolt 36 and the bolt hole 43 or 44 based on the acquired three-dimensional measurement data. Due to this, it is possible to determine whether the lower half part 31 and the upper half part 32 can be properly fastened to each other by the bolts 36, and interference at the time of casing assembly can be estimated with high accuracy.

### REFERENCE SIGNS LIST

10 Steam turbine (rotary machine)
11 Casing
12 Rotor
13 Turbine vane
14 Turbine blade
31 Lower half part
32 Upper half part
33 Turbine
34, 35 Bearing
36 Bolt
41 Lower attachment surface
42 Upper attachment surface
43, 44 Bolt hole
50 Assembly interference determination device for casing
51 Three-dimensional measurement data acquisition unit
52 Three-dimensional data calculation unit
53 Interference presence/absence determination unit
54 Position deviation amount calculation unit
71 Operation unit
72 Output unit
73 Storage unit

1. An assembly interference determination device for a casing that includes a lower half part and an upper half part that are to be fastened to each other, the assembly interference determination device for the casing comprising:
a three-dimensional measurement data acquisition unit configured to acquire three-dimensional measurement data by three-dimensionally measuring a shape of a bolt disposed in one of the lower half part and the upper half part and a shape of a bolt hole disposed in the other of the lower half part and the upper half part; and
an interference presence/absence determination unit configured to determine presence/absence of interference between the bolt and the bolt hole based on the three-dimensional measurement data acquired by the three-dimensional measurement data acquisition unit.

2. The assembly interference determination device for the casing according to claim 1, wherein
the three-dimensional measurement data acquisition unit acquires three-dimensional measurement data of a bolt boundary line between an attachment surface of the lower half part and the bolt,
the assembly interference determination device further comprises a three-dimensional data calculation unit configured to calculate three-dimensional data of a shape of a front end portion of the bolt based on the three-dimensional measurement data of the bolt boundary line acquired by the three-dimensional measurement data acquisition unit, and
the interference presence/absence determination unit determines presence/absence of interference between the bolt and the bolt hole using the three-dimensional data of the shape of the front end portion of the bolt calculated by the three-dimensional data calculation unit.

3. The assembly interference determination device for the casing according to claim 1, wherein
the three-dimensional measurement data acquisition unit acquires three-dimensional measurement data of the shape of the bolt in the lower half part,
the assembly interference determination device further comprises a three-dimensional data calculation unit configured to calculate three-dimensional data of a shape of a front end portion of the bolt based on the three-dimensional measurement data of the bolt acquired by the three-dimensional measurement data acquisition unit, and
the interference presence/absence determination unit determines presence/absence of interference between the bolt and the bolt hole using the three-dimensional data of the shape of the front end portion of the bolt calculated by the three-dimensional data calculation unit.

4. The assembly interference determination device for the casing according to claim 1, wherein
the three-dimensional measurement data acquisition unit acquires three-dimensional measurement data of a center point of a front end portion of the bolt in the lower half part,
the assembly interference determination device further comprises a three-dimensional data calculation unit configured to calculate three-dimensional data of a shape of the front end portion of the bolt based on the three-dimensional measurement data of a position of the center point of the front end portion of the bolt acquired by the three-dimensional measurement data acquisition unit, and
the interference presence/absence determination unit determines presence/absence of interference between the bolt and the bolt hole using the three-dimensional data of the shape of the front end portion of the bolt calculated by the three-dimensional data calculation unit.

5. The assembly interference determination device for the casing according to claim 1, wherein
the three-dimensional measurement data acquisition unit acquires three-dimensional measurement data of a shape of a bolt hole on an attachment surface of the lower half part or the upper half part,
the assembly interference determination device further comprises a three-dimensional data calculation unit configured to calculate three-dimensional data of a shape of a front end portion of the bolt to be mounted into the bolt hole based on the three-dimensional measurement data of the shape of the bolt hole acquired by the three-dimensional measurement data acquisition unit, and
the interference presence/absence determination unit determines presence/absence of interference between the bolt and the bolt hole using the three-dimensional data of the shape of the front end portion of the bolt calculated by the three-dimensional data calculation unit.

6. The assembly interference determination device for the casing according to claim 1, further comprising:
a position deviation amount calculation unit configured to calculate a position deviation amount of the bolt or the bolt hole by comparing the three-dimensional measurement data acquired by the three-dimensional measurement data acquisition unit with design data of the lower half part and the upper half part.

7. An assembly interference determination method for a casing that includes a lower half part and an upper half part that are to be fastened to each other, the assembly interference determination method comprising:
acquiring three-dimensional measurement data by three-dimensionally measuring a shape of a bolt disposed in one of the lower half part and the upper half part and a shape of a bolt hole disposed in the other of the lower half part and the upper half part; and
determining presence/absence of interference between the bolt and the bolt hole based on the acquired three-dimensional measurement data.
